(19) United States
(12) Patent Application Publication
(10) Pub. No.: US 2023/0388359 A1
(43) Pub. Date: Nov. 30, 2023

(54) SYSTEM AND METHOD FOR STREAMING

(71) Applicant: Trevor Dedman, Kitchener (CA)

(72) Inventor: Trevor Dedman, Kitchener (CA)

(21) Appl. No.: 18/203,255

(22) Filed: May 30, 2023

Related U.S. Application Data
(60) Provisional application No. 63/346,962, filed on May 30, 2022.

(51) Int. Cl. H04L 65/65; H04L 65/752; H04N 21/2187; H04N 21/2662

(52) U.S. Cl. CPC H04L 65/65; H04L 65/752; H04N 21/2187; H04N 21/2662

(57) ABSTRACT

Devices and methods for providing streaming data through a webpage are disclosed herein. The device includes a processor, a memory, and at least one user input device. Computer executable instructions are stored in the memory. The computer instruction can be executed by the processor to display, via the display, a webpage and a widget embedded into the webpage. The widget includes a streaming element for processing and displaying streaming data. The widget can be configured to be in electronic communication with a streaming application that generated the streaming data, through an application programming interface. The widget is associated to the streaming application by a unique stream key.

### CROSS-REFERENCE TO RELATED APPLICATIONS

This application claims priority from U.S. Provisional Patent Application No. 63/346,962, filed on May 30, 2022. The entire contents of U.S. Provisional Patent Application No. 63/346,962 are hereby incorporated by reference for all purposes.

### FIELD OF THE DISCLOSURE

The present disclosure relates to devices, systems and methods associated with the production and delivery of digital content streams, and more particularly to providing live video production, editing, delivery and streaming via a computer network.

### BACKGROUND OF THE DISCLOSURE

Increased availability and constant evolution of Internet technology is making it possible to distribute multimedia content to users using the Internet and Internet protocols (IP). Anyone with access to the Internet can become a content provider by uploading digital audio or video to a streaming media service and make the uploaded content available to thousands of users. The operational details of providing access to the users to the uploaded content can be taken care of by the streaming media service platform.

A streaming system facilitates distribution of digital content to users. The streaming system may store content on storage media, such as a magnetic hard drive, that may be available locally or via a storage area network connection. Users may be able to browse through the available content and request transmission of a desired digital content. The content may then be sent to the user's device using one of many possible transmission protocols. Commercially available streaming platforms are often available to streaming media service providers as a “black box” in that the streaming media service providers cannot alter the software but can only build solutions using application programming interfaces (APIs) provided by the streaming media server platforms.

Content providers must overcome several technical challenges for streaming content to multiple users, and more specifically for streaming content to live visitors of a specific website. In particular, there is no streaming platform that allows website owners to convert their website into a streaming delivery platform for improving website stickiness and/or customer interaction to drive sales. Further, there is no known streaming platforms for connecting streamers to organizations for the purpose of being streamed on the organization's website.

The above-mentioned tasks can become even more difficult because of prevailing use of many different video encoding and streaming standards, and implementations of these encoding and streaming standards by different vendors, resulting in many different variations of encoded video bitstreams, and corresponding multiple different versions of streaming media players that receive and display content on websites. For instance, multiplicity of video encoder implementations and/or video player implementations poses an extremely complex technical problem, such as making code changes to the streaming media platform. Furthermore, the streaming media platform operator may be subject to additional complexity by having to test compatibility between the variations in streaming media formats, generated by different encoders and streaming media players, implemented on different websites.

### SUMMARY OF THE DISCLOSURE

According to one embodiment, there is disclosed a device including a processor and memory, a display, at least one user input device, and computer executable instructions stored in the memory, executable by the processor to display, via the display, a webpage and a widget embedded into the webpage, the widget including a streaming element for processing streaming data, the widget being configured to be in electronic communication with a streaming application, generating the streaming data, through an application programming interface, wherein the widget is associated to the streaming application by a unique stream key.

For example, the unique stream key is embedded into a streaming widget code block associated with the widget and the widget is identified by the application programming interface by using the unique stream key such that the application programming interface is configured to route the streaming data generated by the streaming application to the widget.

For example, the unique stream key is generated by one or more servers and the unique stream key is embedded into the streaming widget code block associated with the widget by the one or more servers prior to embedment of the streaming widget code block into a source code of the webpage.

For example, the streaming data is real-time or near real-time streaming data.

For example, the application programming interface is configured to format the streaming data generated by the streaming application into a format suitable for display by the widget.

For example, the application programming interface is configured to format the streaming data by changing a bitrate of the streaming data and/or transcoding from one protocol to another protocol prior to transmission of the formatted streaming data to the widget.

For example, the streaming data includes video data and/or audio data.

For example, the widget further includes a chat element for processing chat data.

The device is a mobile device, a point of sale device, a personal computer, a laptop, a tablet, an hand-held device, a wearable device and/or a gaming device.

According to one embodiment, there is disclosed a method for providing streaming data, including: providing a streaming application for generating streaming data; providing an application programming interface for processing the streaming data generated by the streaming application; and providing, via a device display, a webpage and a widget embedded into the webpage, the widget including a streaming element for processing streaming data, the widget being configured to be in electronic communication with the streaming application through the application programming interface, wherein the widget is associated to the streaming application by a unique stream key.

For example, the method includes generating the unique stream key; and embedding the unique stream key into a streaming widget code block associated with the widget prior to embedment of the streaming widget code block into a source code of the webpage.

For example, the method includes generating the streaming data by the streaming application; and formatting, by the application programming interface, the streaming data into a format suitable for display by the widget embedded into the webpage.

For example, the method includes formatting, by the application programming interface, the streaming data by changing a bitrate of the streaming data and/or transcoding from one protocol to another protocol prior to transmission of the formatted streaming data to the widget.

According to one embodiment, there is disclosed an apparatus for generating a streaming widget, including: a memory; a processor in communication with said memory, and configured to issue a plurality of processing instructions stored in the memory, wherein the processor issues instructions to: obtain, via a website hosted on a server, widget customization parameters; generate a streaming widget code block based on the obtained widget customization parameters, wherein a unique stream key is embedded into the streaming widget code block such that a widget can be identified by an application programming interface by using the unique stream key; and provide the streaming widget code block.

According to one embodiment, there is disclosed a method for generating a streaming widget code block, including: obtaining, via a website hosted on a server, widget customization parameters from a user; generating a streaming widget code block based on the obtained widget customization parameters, wherein a unique stream key is embedded into the streaming widget code block such that a widget can be identified by an application programming interface by using the unique stream key; and providing the streaming widget code block.

According to one embodiment, there is disclosed a system for connecting streamers to organizations for the purpose of being streamed on the organization's website, including a computer processor; and a computer-readable storage device comprising computer code stored thereon which, when executed by the computer processor, causes the computer processor to perform operations comprising: identifying a streamer for livestreaming electronic content; identifying an organization seeking to collaborate with streamers for livestreaming on an organization's website; and matching the streamer and the organization for collaboration based on one or more selection criteria.

For example, the operations further include providing a streaming application to the streamer for generating streaming data.

For example, the operations further include providing an application programming interface for processing the streaming data generated by the streaming application.

For example, the operations further include providing a widget to the organization for embedment into the organization's website, the widget including a streaming element for processing streaming data, the widget being configured to be in electronic communication with a streaming application, generating the streaming data, through an application programming interface.

For example, the widget can be associated to the streaming application by a unique stream key.

For example, the unique stream key is embedded into the widget and the widget is identified by the application programming interface by using the unique stream key such that the application programming interface is configured to route the streaming data generated by the streaming application to the widget.

For example, the operations further include generating a unique stream key and embedding the unique stream key into a streaming widget code block associated with the widget prior to embedment of the streaming widget code block into a source code of the organization's website.

For example, the streaming data can be real-time or near real-time streaming data.

According to one embodiment, there is disclosed a method for connecting streamers to organizations for the purpose of being streamed on the organization's website, including: identifying a streamer for livestreaming electronic content; identifying an organization seeking to collaborate with streamers for livestreaming on an organization's website; and matching the streamer and the organization for collaboration based on one or more selection criteria.

For example, the method further includes providing a streaming application to the streamer for generating streaming data.

For example, the method further includes providing an application programming interface for processing the streaming data generated by the streaming application.

For example, the method further includes providing a widget to the organization for embedment into the organization's website, the widget comprising a streaming element for processing streaming data, the widget being configured to be in electronic communication with a streaming application, generating the streaming data, through an application programming interface.

For example, the widget is associated to the streaming application by a unique stream key.

For example, the unique stream key is embedded into the widget and the widget is identified by the application programming interface by using the unique stream key such that the application programming interface is configured to route the streaming data generated by the streaming application to the widget.

For example, the method further includes generating a unique stream key and embedding the unique stream key into a streaming widget code block associated with the widget prior to embedment of the streaming widget code block into a source code of the organization's website.

For example, the streaming data is real-time or near real-time streaming data.

### BRIEF DESCRIPTION OF THE DRAWINGS

FIG. 1 shows an embodiment of a system for broadcasting and delivery of live streaming according to one example.

FIG. 2 shows an exemplary embodiment of a stream service provider interface.

FIG. 3 shows an exemplary device for streaming.

FIG. 4 shows a method for generating a streaming widget code block according to one example.

FIG. 5 shows a method for connecting streamers to organizations for the purpose of being streamed on the organization's website according to one example.

### DETAILED DESCRIPTION OF THE DISCLOSURE

The present subject matter relates to improvement of video streaming technology.

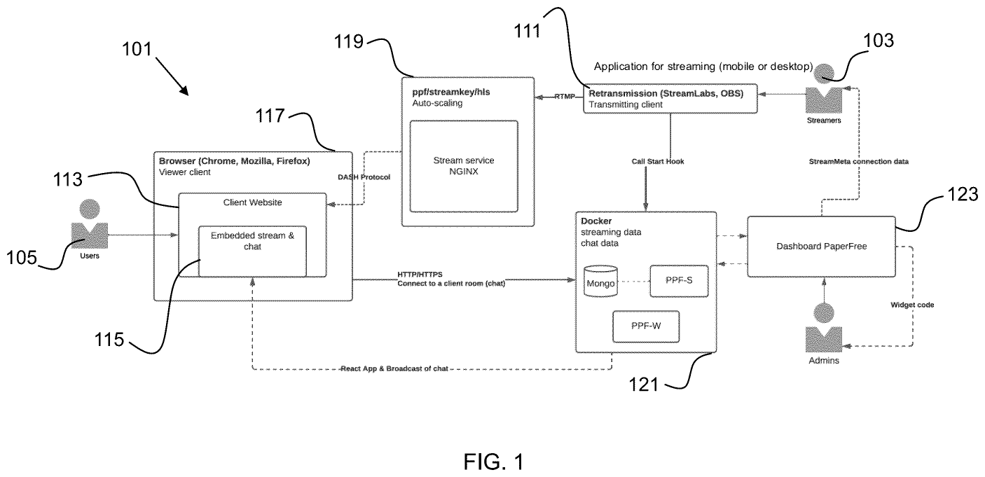

Referring to FIG. 1, there is disclosed an exemplary embodiment of a system 101 for an improved video production, editing, broadcasting, delivery and live streaming. Users of the system described herein can be connected to a network, such as the internet or other wire and/or wireless communication networks, local-area networks (LAN), wide-area networks (WAN), cellular networks, etc. In this exemplary embodiment, the system allows a streamer 103 to create and broadcast live streams, which may be embedded with other digital content streams, over a network through use of one or more multiple communicating servers interconnected. For example, the streamer 103 may be able to edit and control delivery of live streams over a network to multiple viewers on multiple platforms.

As explained in the present disclosure, the system 101 allows for clients (for e.g., streamers, website owners, etc.) to register and pay through an online service and/or platform (for e.g., a website, an application, etc.) and receive a stream key and a code snippet of a widget, which they can embed in their website. The stream key allows clients to live stream from a streaming application 111 (for e.g., Stream Labs, OBS) to a website 113 that has a streaming widget embedded into its source code. A unique stream key and a streaming widget code block (i.e., a code snippet) are generated by one or more servers of the system for each client. The unique stream key is embedded into the streaming widget code block associated with a specific client widget by the servers of the system prior to embedment of the streaming widget code block into a source code of a webpage of the client. Multiple stream keys and code blocks may be generated depending on the client needs and web infrastructure.

As mentioned above, a unique stream key is embedded into a streaming widget code block associated with a widget. The widget is identified by an application programming interface (API) by using the unique stream key such that the application programming interface is configured to route live streams generated by a particular streamer to a specific widget selected and/identified by the streamer. Advantageously, using this system, the streamer has the ability to select which widget(s) to stream to, which translates to selection of specific websites to stream to.

Once the streaming widget code block is embedded into a source code of a webpage and the webpage is rendered by an Internet browser 117, a widget 115 is added to the website 113. Please note that a webpage is a single document on the web using a unique URL, while a website is a collection of multiple webpages in which information on a related topic or another subject is linked together under the same domain address.

The widget 115 can be an element of a graphical user interface (GUI) that displays data (e.g., stream data, video, audio, graphic elements, polls, etc.) and/or provides a specific way for a user to interact with a system or an application. For example, the widget 115 can be a floating tab. For example, the widget 115 may be visible to Internet users that are visiting the website 113 linked to the webpage. For example, the widget allows for video streaming and integrated chat. Internet users can click on the widget 115 to watch live streams generated by the streamer 103 and/or chat with the streamer 103.

Referring back to FIG. 1, the system includes a streaming application 111. The streaming application 111 can run on a computing system such as a desktop computer, a tablet, a cell phone, a personal computer, a laptop, a tablet, a hand-held device, a wearable device, a gaming device, etc. The computing system can include input devices (such as a microphone, a camera, a capture card, a keyboard, etc.). Live stream data can be generated by the input devices. For example: the microphone can capture audio from the streamer and generate audio data therefrom; the camera can capture an image and/or video of the streamer and generate video data therefrom; and the keyboard can capture chat data from the streamer. Streaming data generated by the input devices are captured and/or stored by the streaming application 111.

The streaming application 111 can be operated by a streamer 103 to initiate and/or control live streams (including the streaming data) delivered to the streaming widget 115. The streaming application 111 delivers the live stream to the streaming widget 115 through an application programming interface (API) 119. In one embodiment, the streaming application 111 may be a web editor including a graphical user interface (GUI) on a streamers computing system and may be configured as a website using HTTP or other similar protocol, with which the user interacts to operate a live stream such as a video production project. Each video production project can allow a streamer to manipulate, initiate and/or control any of a multitude of live streams. The system can include one or more servers that store, receive and/or host the streamer's live stream including the various streaming data.

Using the streaming application 111, a streamer can perform a number of functions and operations associated to streaming. The streaming application 111 can provide a user a visual graphical user interface workspace and control panel for the assembly, manipulation and production of live stream broadcasts, including features such as, but not limited to, video broadcast project management, starting a stream, stopping a stream, adding and/or removing digital content streams, digital content assets, users, switching between broadcast scenes, application of filters, etc. Manipulation of live streams may further include, but is not limited to, video and image asset layering, volume control, on-screen text, graphic animation, etc.

A user, through the streaming application, can perform these functions and operations, and the application 111 can translate these functions and operations into digital content stream preferences, general application/user settings, and user-credential related data, all of which are regularly recorded in and retrieved from databases stored on servers of the system. Further, the streaming application 111 can be the recipient of network traffic and act as a preview service of live streams and/or digital assets stored in a cloud storage of the system.

Referring back to FIG. 1, the system further includes an application programming interface (API) 119. The application programming interface 119 is in electronic communication with the streaming application 111 and the streaming widget 115. The application programming interface 119 can operate as an ingest and encoding system which is responsible for the processing and formatting of one or multiple streams from the streaming application 111. For example, the application programming interface 119 can change the bitrate of a stream and/or the transcoding from one protocol such as RTMP to another protocol such as Dash, RTP, WebRTC, or other such streaming protocols as would be known to one skilled in the art. For example, DASH (i.e., Dynamic Adaptive Streaming over HTTP), also known as MPEG-DASH, is an adaptive bitrate streaming technique that enables high quality streaming of media content over the Internet.

In one embodiment, the system can broadcast multiple streams initiated by a user, processed through the streaming application to create a composite stream which can then be broadcast to multi third-party platforms (e.g., devices, etc.) through the application programming interface. For example, each of the third-party platforms can receive a stream from the application programming interface as a cloned stream transcoded into a respective required format and/or protocol by the application programming interface. A unique stream key can be embedded into a streaming widget code block associated with a widget of a third party platform. The widget can be identified by the application programming interface by using the unique stream key such that the application programming interface is configured to route the streaming data generated by the streaming application to the widget. The broadcasting of a live stream to one third party or multiple third party streaming platforms can also be accomplished through the user being credentialed through a user login system existing on a web application. The user credentials can be stored in a database on a server.

Referring back to FIG. 1, there is shown an Internet browser 117. The Internet browser is application software for accessing the World Wide Web or a local website. For example, when a user requests a web page from a particular website, the web browser retrieves the necessary content from a web server and then displays the page on the user's device. Browsers can be used on devices such as desktops, laptops, tablets, and smartphones.

The Internet browser 117 can display the website 113 using HTTP or other similar protocol. The webpage is a hypertext document on an information space such as the World Wide Web (WWW) where documents and other web resources can be accessed through the Internet using a browser. The website 113 can be delivered by a web server to the user 105 and displayed in the web browser 117. The website 113 can consist of many webpages linked together under a common domain name.

As previously mentioned, a streaming widget code block can be embedded into a source code of a webpage of the website 113. After such embedment and once the webpage is rendered by the Internet browser 117, the widget 115 is added to the website 113. A widget is an element of a graphical user interface (GUI) that displays information or provides a specific way for a user to interact with an operating system or an application implemented on a device.

The widget can be in electronic communication with a streaming application through an application programming interface. The streaming application can generate streaming data. The streaming data can be real-time or near real-time streaming data. The streaming data can include video data and/or audio data. The real-time or near real-time streaming data can be generated by the streaming application and processed by the application programming interface. The application programming interface can be configured to format the streaming data generated by the streaming application into a format suitable for display by the widget.

The widget can receive the streaming data from the streaming application through the application programming interface. The widget can be associated to the streaming application by a unique stream key. The unique stream key can be embedded into a streaming widget code block associated with the widget. The widget can be identified by the application programming interface by using the unique stream key such that the application programming interface is configured to route the streaming data generated by the streaming application to the widget.

The unique stream key can be generated by one or more servers. The unique stream key can be embedded into the streaming widget code block associated with the widget by the one or more servers prior to embedment of the streaming widget code block into a source code of the webpage.

In one embodiment, the widget can include a streaming element for processing and/or displaying streaming data.

In another embodiment, the widget can also include a chat element for processing chat data. The chat element can enable real-time text-based interactive discussion between multiple users of the system.

In a further embodiment, the widget can include an audio/video chat element, an audio recording/playback element, at least one video recording/playback element, an audio/video editing element, a document viewing/editing element, a diagram editing/viewing element, a whiteboard element, a polling element, a survey element, a user list element, a screen sharing element, or any combination thereof. For example, the audio/video chat element can enable real-time audio and video chat between users of the system through their respective devices. For example, each user can simultaneously view real-time video and audio feeds/streams being broadcast from many users of the system. Furthermore, the audio/video chat element can support a record mode and can be used to record a user's audio and/or video input for use in a variety of ways.

The document viewing element can enable a user to load and view text based documents in various formats (e.g., Microsoft Office, PDF). The whiteboard element can enable a user to draw a diagram individually (e.g., visible to only one user) or collaboratively (e.g., with other users in real-time (e.g., live) and non real-time (e.g., non-live). The polling element can enable a user to define and/or participate in question based polls, both in real-time and non-real time. The survey element can enable a user to define and participate in surveys, both in real-time and non-real time. The user list element can allow for users of the system to see information about other users of the system, and/or interact with other users or solicit interactions with other users of the system.

Referring to FIG. 1, there is shown a docker 121 for processing chat data from users. The docker is in electronic communication with the widget 115 and the stream application 111. The docker includes a database (for e.g., MongoDB) for real-time chat database. The docker 121 can be run on the same server as the application programming interface 119; or the docker and the application programming interface can be run on different servers. For example, in one embodiment, the chat docker is not expected to require much scaling; whereas the stream application programming interface could require a lot of scaling very quickly because it could process a lot of data depending on the amount of users.

Referring back to FIG. 1, there is shown a dashboard 123. The dashboard provides an interface (for e.g., GUI) between a user and the system for managing streams. For example, the dashboard can include a website. For example, using the dashboard, a user can generate stream keys. To generate a stream key: a user logs into the website; the user can create an account; and the user can pick up a stream package and pay for the package using electronic payment (credit card, etc.). A key (for e.g., a key that the user needs for the streaming application/Stream Labs/etc.) will be then provided to the user on the dashboard of the website and the user would be able to copy-paste the key and begin a stream. The user would also get a little snippet of code (which is the code for the widget) that the user (or a web developer) can insert into the source code of the user's website. Because of that snippet of code, when the website loads onto a browser, the widget will be visible to a user.

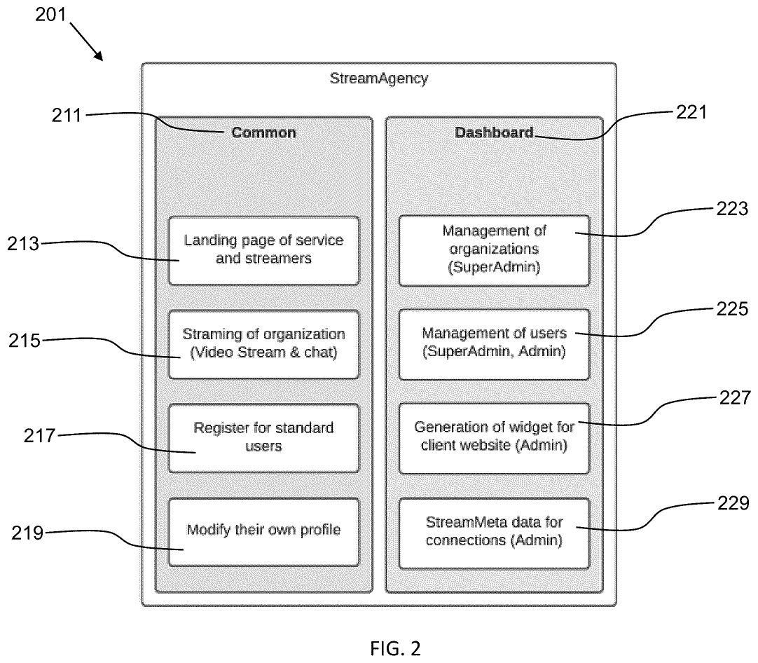

Referring to FIG. 2, there is shown an exemplary embodiment of a website 201 for a stream service provider. Under the common tab 211, there are shown common services that are public to all users. The common services can include: landing page of service and streamers 213; streaming of organization (video stream and chat) 215; registration for standard users 217; modification of user profile 219. Under the service tab, there are shown a dashboard 221 of services that are available to clients of the stream service provider when they log into the website. The client services can include: management of organization (super admin) 223; management of users (super admin, admin) 225; generation of widget for client website (admin) 227; and streaming meta data for connections (admin) 229.

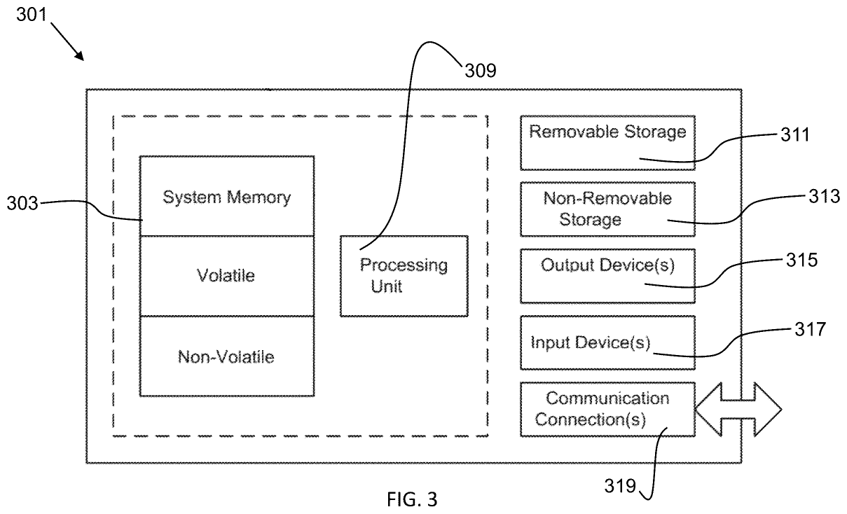

Referring to FIG. 3, there is shown an exemplary computing environment in which example embodiments and aspects of the present subject matter may be implemented. The computing device environment is only one example of a suitable computing environment and is not intended to suggest any limitation as to the scope of use or functionality. Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 3, an exemplary system for implementing aspects described herein includes a device, such as computing device 301. In its most basic configuration, computing device 301 typically includes at least one processing unit 309 and memory 303. Depending on the exact configuration and type of computing device, memory 303 may include volatile memory (such as random access memory (RAM)), non-volatile memory (such as read-only memory (ROM), flash memory, etc.), or some combination.

Computing device 301 may have additional features/functionality. For example, computing device 301 may include additional storage (removable and/or non-removable) including, but not limited to, magnetic or optical disks or tape. Such additional storage is illustrated in FIG. 3 by removable storage 311 and non-removable storage 313.

Computing device 301 can includes a variety of computer readable media. Computer readable media can be any available media that can be accessed by the device 301 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 303, removable storage 311, and non-removable storage 313 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 301 may contain communication connection(s) 319 that allow the device to communicate with other devices. Computing device 301 may also have input device(s) 317 such as a keyboard, mouse, pen, voice input device, touch input device, etc. Output device(s) 315 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

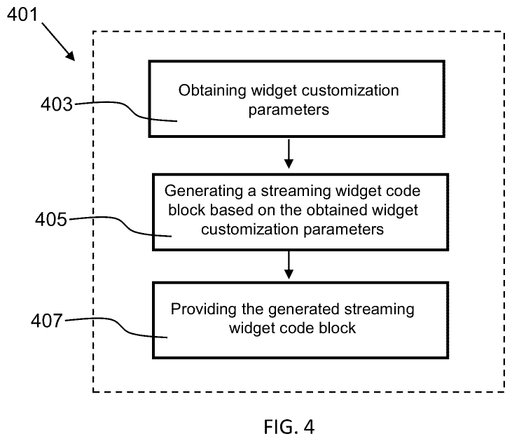

Referring to FIG. 4, there is disclosed a method 401 for generating a streaming widget code block. At 403, the method includes obtaining widget customization parameters. For example, the parameters can be obtained from a website hosted on a server. For example, the parameters can be obtained from the dashboard described in FIG. 1 or 2. At 405, the method includes generating a streaming widget code block based on the obtained widget customization parameters. For example, a device or server can automatically generate the streaming widget code. When generated, a unique stream key is embedded into the streaming widget code block such that a widget can be identified by an application programming interface by using the unique stream key. Using the key, the application programming interface can be configured to route streaming data generated by the streaming application to the widget.

At 407, the method includes providing the generated streaming widget code block. The generated streaming widget code block can be provided to a user through a website (such as the dashboard provided herein) or a server by email, text, or any other means of electronic communication.

An apparatus for generating a streaming widget is provided herein. The apparatus includes a memory and a processor in communication with the memory, and configured to issue a plurality of processing instructions stored in the memory. The processor can issue instructions to obtain, via a website hosted on a server, widget customization parameters from a user of the website; generate a streaming widget code block based on the obtained widget customization parameters; and provide the streaming widget code block to a GUI of the device.

According to one embodiment, the present subject matter discloses a streaming system (i.e., computer platform) for connecting streamers to organizations for the purpose of being streamed on the organization's website. The system can provide streamers and organizations with the tools they need to effectively manage all their streaming needs. The system can deliver the benefits that come from connecting streamers and organizations together in the cloud, while supporting organizational relationships with all types of streamers, and supporting all aspects of streaming engagement and management through electronic commerce.

For example, the system features are designed to make it easy to connect streamers and organizations for enabling: easy reach and engagement with streamers and organizations that might want to do business with each other; an organization to do business with a streamer, by enabling an organization to search for, compare, engage and collaborate with a streamer registered within the system; a streamer to search for an organization to do business with, by enabling a streamer to search for, compare, engage and collaborate with an organization registered within the system; streamers and organizations engage and perform electronic commerce with each other.

The system can provide capabilities of a platform portal or e-Marketplace, including a central “commerce hub” where: streamers and/or organizations can register and maintain their profile, catalogue and service information; streamers can view registered organizations and invite them to be part of their private marketplace and/or collaborate; organizations can view registered streamers and invite them to be part of their private marketplace and/or collaborate; streamers can be made easily accessible to organizations; organizations can be made easily accessible to streamers; streamers and/or organizations can automate the exchange of electronic order and invoice documents.

A computer system for connecting streamers to organizations for the purpose of being streamed on the organization's website is provided herein. The system includes a computer processor and a computer-readable storage device as previously disclosed in the present disclosure. The computer-readable storage device includes computer code stored thereon which, when executed by the computer processor, causes the computer processor to perform operations including: identifying a streamer for livestreaming electronic content; identifying an organization seeking to collaborate with streamers for livestreaming on an organization's website; and matching the streamer and the organization for collaboration based on one or more selection criteria. The selection criteria can include: popularity of the streamer; streamer's engagement with a particular online audience/online community; streamer's growth; prices; reputation of the streamer and/or organization; streamer's fitness with a particular online campaign; recommendations by others; and existing relationships.

The operations can include: providing a streaming application to the streamer for generating streaming data; providing an application programming interface for processing the streaming data generated by the streaming application; and providing a widget to the organization for embedment into the organization's website, the widget including a streaming element for processing streaming data, the widget being configured to be in electronic communication with a streaming application, generating the streaming data, through an application programming interface.

The widget can be associated to the streaming application by a unique stream key. For example, the unique stream key is embedded into the widget and the widget is identified by the application programming interface by using the unique stream key such that the application programming interface is configured to route the streaming data generated by the streaming application to the widget.

The operations can further include generating a unique stream key and embedding the unique stream key into a streaming widget code block associated with the widget prior to embedment of the streaming widget code block into a source code of the organization's website. For example, the streaming data can be real-time or near real-time streaming data.

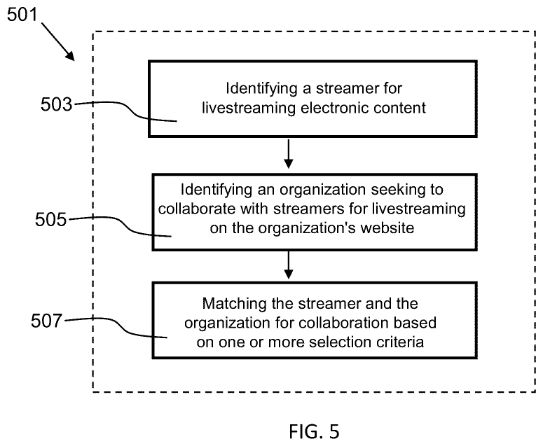

Referring to FIG. 5, there is shown a method 501 for connecting streamers to organizations for the purpose of being streamed on the organization's website. At 503, the method includes identifying a streamer for livestreaming electronic content. At 505, the method includes identifying an organization seeking to collaborate with streamers for livestreaming on the organization's website. At 507, the method includes matching the streamer and the organization for collaboration based on one or more selection criteria. The selection criteria can include: popularity of the streamer; streamer's engagement with a particular online audience/online community; streamer's growth; prices; reputation of the streamer and/or organization; streamer's fitness with a particular online campaign; recommendations by others; and existing relationships.

The method can further include: providing a streaming application to the streamer for generating streaming data; and/or providing an application programming interface for processing the streaming data generated by the streaming application.

The method can further include providing a widget to the organization for embedment into the organization's website, the widget comprising a streaming element for processing streaming data, the widget being configured to be in electronic communication with a streaming application, generating the streaming data, through an application programming interface.

For example, the widget is associated to the streaming application by a unique stream key. For example, the unique stream key is embedded into the widget and the widget is identified by the application programming interface by using the unique stream key such that the application programming interface is configured to route the streaming data generated by the streaming application to the widget.

The method can further include generating a unique stream key and embedding the unique stream key into a streaming widget code block associated with the widget prior to embedment of the streaming widget code block into a source code of the organization's website. For example, the streaming data is real-time or near real-time streaming data.

The drawings and the forgoing description give examples of embodiments. Those skilled in the art will appreciate that one or more of the described elements may well be combined into a single functional element.

Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples

1. A device comprising:
a processor and memory;
a display;
at least one user input device;
computer executable instructions stored in said memory, executable by said processor to display, via the display, a webpage and a widget embedded into the webpage,
the widget comprising a streaming element for processing streaming data,
the widget being configured to be in electronic communication with a streaming application, generating the streaming data, through an application programming interface,
wherein the widget is associated to the streaming application by a unique stream key.

2. The device of claim 1, wherein the unique stream key is embedded into a streaming widget code block associated with the widget and the widget is identified by the application programming interface by using the unique stream key such that the application programming interface is configured to route the streaming data generated by the streaming application to the widget.

3. The device of claim 2, wherein the unique stream key is generated by one or more servers and the unique stream key is embedded into the streaming widget code block associated with the widget by the one or more servers prior to embedment of the streaming widget code block into a source code of the webpage.

4. (canceled)

5. The device of claim 4, wherein the streaming data is real-time or near real-time streaming data and the real-time or near real-time streaming data are generated by the streaming application and processed by the application programming interface, and wherein the application programming interface is configured to format the streaming data generated by the streaming application into a format suitable for display by the widget.

6. The device of claim 5, wherein the application programming interface is configured to format the streaming data by changing a bitrate of the streaming data and/or transcoding from one protocol to another protocol prior to transmission of the formatted streaming data to the widget.

7. The device of claim 1, wherein the streaming data comprises video data and/or audio data and the widget further comprises a chat element for processing chat data.

8. (canceled)

9. The device of claim 1, wherein the device is a mobile device, a point of sale device, a personal computer, a laptop, a tablet, an hand-held device, a wearable device and/or a gaming device.

10. A method for providing streaming data, comprising:
providing a streaming application for generating streaming data;
providing an application programming interface for processing the streaming data generated by the streaming application; and
providing, via a device display, a webpage and a widget embedded into the webpage, the widget comprising a streaming element for processing streaming data, the widget being configured to be in electronic communication with the streaming application through the application programming interface, wherein the widget is associated to the streaming application by a unique stream key.

11. The method of claim 10, wherein the unique stream key is embedded into the widget and the widget is identified by the application programming interface by using the unique stream key such that the application programming interface is configured to route the streaming data generated by the streaming application to the widget.

12. The method of claim 10, comprising
generating the unique stream key; and
embedding the unique stream key into a streaming widget code block associated with the widget prior to embedment of the streaming widget code block into a source code of the webpage.

13. (canceled)

14. The method of claim 13, comprising
generating the streaming data by the streaming application, the streaming data being real-time or near real-time streaming data;
formatting, by the application programming interface, the streaming data into a format suitable for display by the widget embedded into the webpage.

15. The method of claim 14, further comprising:
formatting, by the application programming interface, the streaming data by changing a bitrate of the streaming data and/or transcoding from one protocol to another protocol prior to transmission of the formatted streaming data to the widget.

16. The method of claim 10, wherein the streaming data comprises video data and/or audio data and the widget further comprises a chat element for processing chat data.

17. (canceled)

18. The method of claim 10, wherein the device comprises a mobile device, a point of sale device, a personal computer, a laptop, a tablet, an hand-held device, a wearable device and/or a gaming device.

19. (canceled)

20. (canceled)

21. A system for connecting streamers to organizations for the purpose of being streamed on the organization's website, comprising
a computer processor; and
a computer-readable storage device comprising computer code stored thereon which, when executed by the computer processor, causes the computer processor to perform operations comprising:
identifying a streamer for livestreaming electronic content;
identifying an organization seeking to collaborate with streamers for livestreaming on an organization's website; and
matching the streamer and the organization for collaboration based on one or more selection criteria.

22. The system of claim 21, wherein the operations further comprise providing a streaming application to the streamer for generating streaming data.

23. The system of claim 22, wherein the operations further comprise providing an application programming interface for processing the streaming data generated by the streaming application.

24. The system of claim 23, wherein the operations further comprise providing a widget to the organization for embedment into the organization's website, the widget comprising a streaming element for processing streaming data, the widget being configured to be in electronic communication with a streaming application, generating the streaming data, through an application programming interface.

25. (canceled)

26. The system of claim 25, wherein the widget is associate to the steaming application by a unique stream key embedded into the widget and the widget is identified by the application programming interface by using the unique stream key such that the application programming interface is configured to route the streaming data generated by the streaming application to the widget.

27. The system of claim 21, wherein the operations further comprise generating a unique stream key and embedding the unique stream key into a streaming widget code block associated with the widget prior to embedment of the streaming widget code block into a source code of the organization's website.

28. (canceled)

29. (canceled)

30. (canceled)

31. (canceled)

32. (canceled)

33. (canceled)

34. (canceled)

35. (canceled)

36. (canceled)
